(19) United States
(12) Patent Application Publication
(10) Pub. No.: US 2008/0270846 A1
(43) Pub. Date: Oct. 30, 2008

(54) Methods and Apparatus for Compiling and Displaying Test Data Items

(76) Inventors: Kristin Petersen, Clifton Park, NY (US); Carli Connally, Fort Collins, CO (US)

Correspondence Address: Gregory W. Osterloth;Holland & Hart, LLP, P.O. Box 8749, Denver, CO, 80201, US

(21) Appl. No.: 11/740,746

(22) Filed: Apr. 26, 2007

(51) Int. Cl. G06F 11/00

(52) U.S. Cl. 714/46

(57) ABSTRACT

In one embodiment, different sets of test data items are serially compiled in, and serially read from, a data storage resource. Each of the sets of test data items corresponds to one of a plurality of defined groupings of devices under test. As the different sets of test data items are read from the data storage resource, at least a dynamically updated range of the test data items read from the data storage resource is displayed via a user interface. Before compiling a next set of test data items in the data storage resource, a previously compiled set of test data items is cleared from the data storage resource, thereby clearing any of the previously compiled set of test data items from the user interface. Other embodiments are also disclosed.

### BACKGROUND

When testing circuit devices such as system-on-a-chip (SOC) devices, both production tests and debug tests may be executed. As defined herein, “production tests” are those tests that are executed during the ordinary course of device testing, while “debug tests” are those tests that are executed for the purpose of extracting additional test data for the purpose of debugging a problem, or monitoring a trend, seen in one or more tested devices. Debug tests can also include tests that are used to debug the operation or effectiveness of a test itself.

When executing production tests, a user might want to acquire and view test data very quickly. In such a case, it is preferable to store the test data in memory. However, when executing debug tests, a user might want to capture a large amount of detailed test data, and the test data may not fit in memory. In this case, it may be necessary to store the test data on disk (e.g., in a database). A problem, however, is that most test applications are configured to either 1) store all test data in memory, or 2) store all test data on disk.

If a test application is configured to store all test data in memory, the test data does not fit in memory, older data may be discarded to make way for newer data. On the other hand, if a test application is configured to store all test data on disk, a user may not be able to view test data as quickly as they would like.

In some cases, the above problem is resolved by developing two separate test applications—one for acquiring and viewing production test data, and one for acquiring and viewing debug test data. However, dual test applications do not use resources efficiently, and a user may be required to learn two different interface structures.

### BRIEF DESCRIPTION OF THE DRAWINGS

Illustrative embodiments of the invention are illustrated in the drawings, in which:

FIG. 1 illustrates an exemplary computer-implemented method for compiling and displaying test data items;

FIGS. 2 & 3 illustrate exemplary windows of a graphical user interface (GUI) that may be configured using the method shown in FIG. 1;

FIG. 4 illustrates an exemplary test system to which the method shown in FIG. 1 may be applied;

FIG. 5 illustrates an exemplary “production test mode” of the test system shown in FIG. 4;

FIG. 6 illustrates an exemplary “debug test mode” of the test system shown in FIG. 4;

FIG. 7 illustrates an exemplary implementation of the user interface displayed by the method shown in FIG. 1; and

FIG. 8 illustrates how the method shown in FIG. 1 may be applied to the test system shown in FIG. 4.

### DETAILED DESCRIPTION

As a preliminary manner, it is noted that, in the following description, like reference numbers appearing in different drawing figures refer to like elements/features. Often, therefore, like elements/features that appear in different drawing figures will not be described in detail with respect to each of the drawing figures.

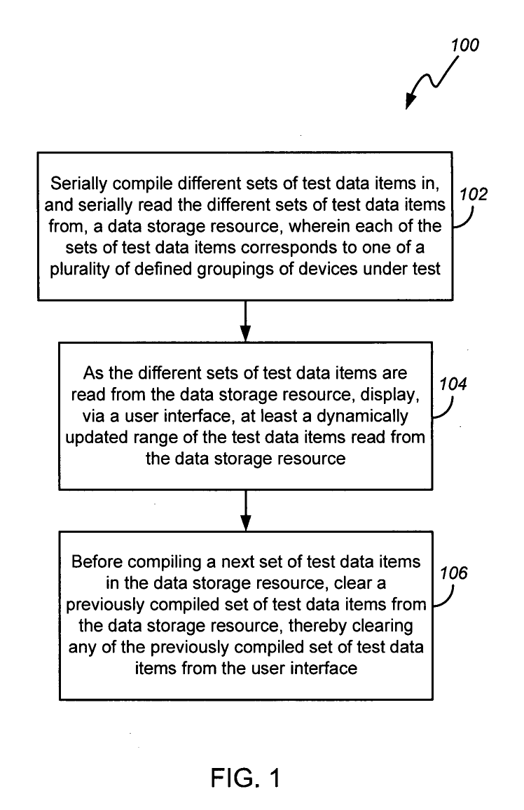

In accord with one embodiment of the invention, FIG. 1 illustrates a computer-implemented method 100 for compiling and displaying test data items. The method 100 comprises serially compiling different sets of test data items in, and serially reading the different sets of test data items from, a data storage resource. See, block 102. Each of the sets of test data items corresponds to one of a plurality of defined “groupings” of devices under test, such as “lots” of devices. The devices under test themselves may take various forms, such as memory devices or system-on-a-chip devices.

As the different sets of test data items are read from the data storage resource, at least a dynamically updated range of the test data items read from the data storage resource is displayed via a user interface (although in some cases, all of the test data items may be displayed via the user interface). See, block 104. Before a next set of test data items is compiled in the data storage resource, a previously compiled set of test data items is cleared from the data storage resource, thereby clearing any of the previously compiled set of test data items from the user interface. See, block 106.

By way of example, the data storage resource in which the sets of test data items are compiled could comprise volatile storage (such as random access memory (RAM), a data table stored in RAM, or a display buffer) or nonvolatile storage (such as a hard disk). The test data items that are compiled in the data storage resource may, for example, take the form of: raw test data items, compiled or processed test data items, test context data items, or test statistics. In one embodiment, the test data items may pertain to tests of a system-on-a-chip (SOC) device, such as tests that have been executed by the V93000 SOC tester distributed by Verigy Ltd. However, the test data items could also pertain to tests that are executed by other sorts of testers, or tests that are executed on other sorts of circuit devices. In some cases, the test data items may be provided by, or derived from, one of the data formatters disclosed in the United States patent application of Connally, et al. entitled “Apparatus for Storing and Formatting Data” (Ser. No. 11/345,040).

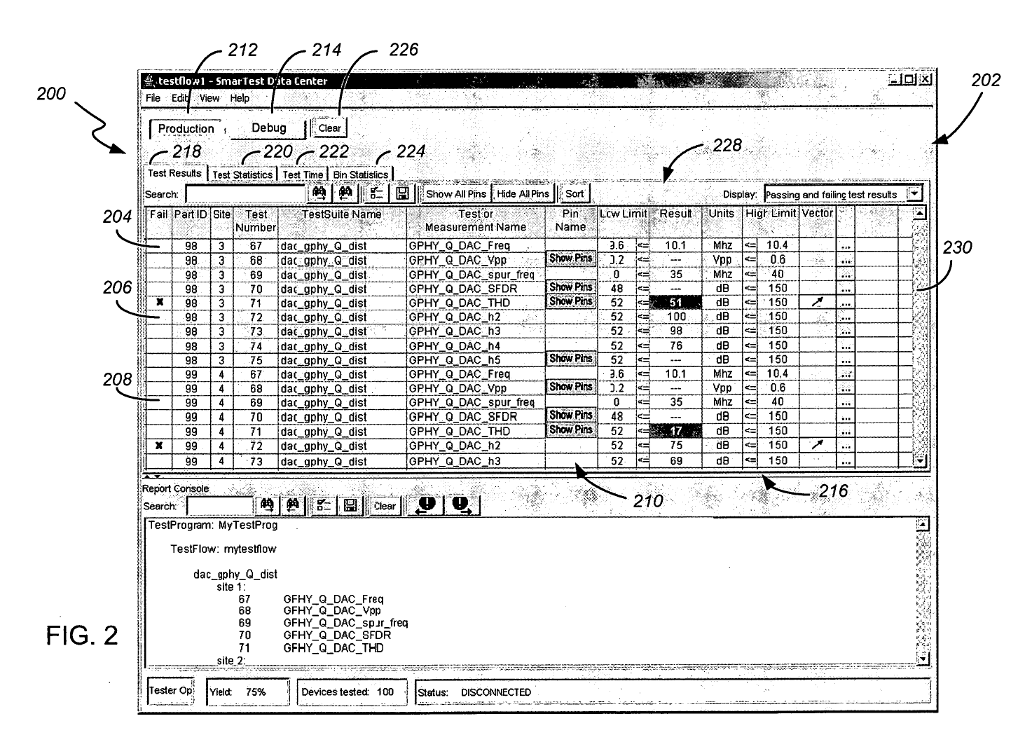

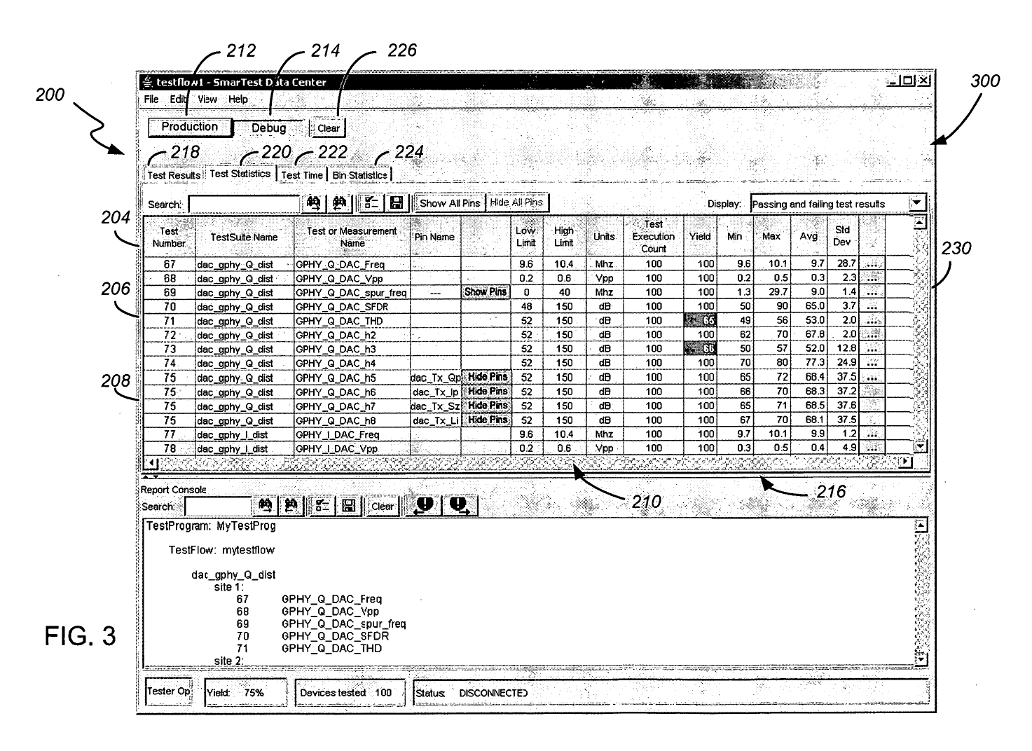

FIG. 2 illustrates a first exemplary window 202 of a graphical user interface (GUI) 200 that may be used to display the test data items displayed by the method 100. The window 202 displays a plurality of test data items that include test results. FIG. 3 illustrates a second exemplary window 300 of the GUI 200. The window 300 displays a plurality of test data items that include test statistics.

The method 100 shown in FIG. 1 may be implemented by means of computer-readable code stored on computer-readable media. The computer-readable media may include, for example, any number or mixture of fixed or removable media (such as one or more fixed disks, RAMs, read-only memories (ROMs), or compact discs), at either a single location or distributed over a network. The computer-readable code will typically comprise software, but could also comprise firmware or a programmed circuit.

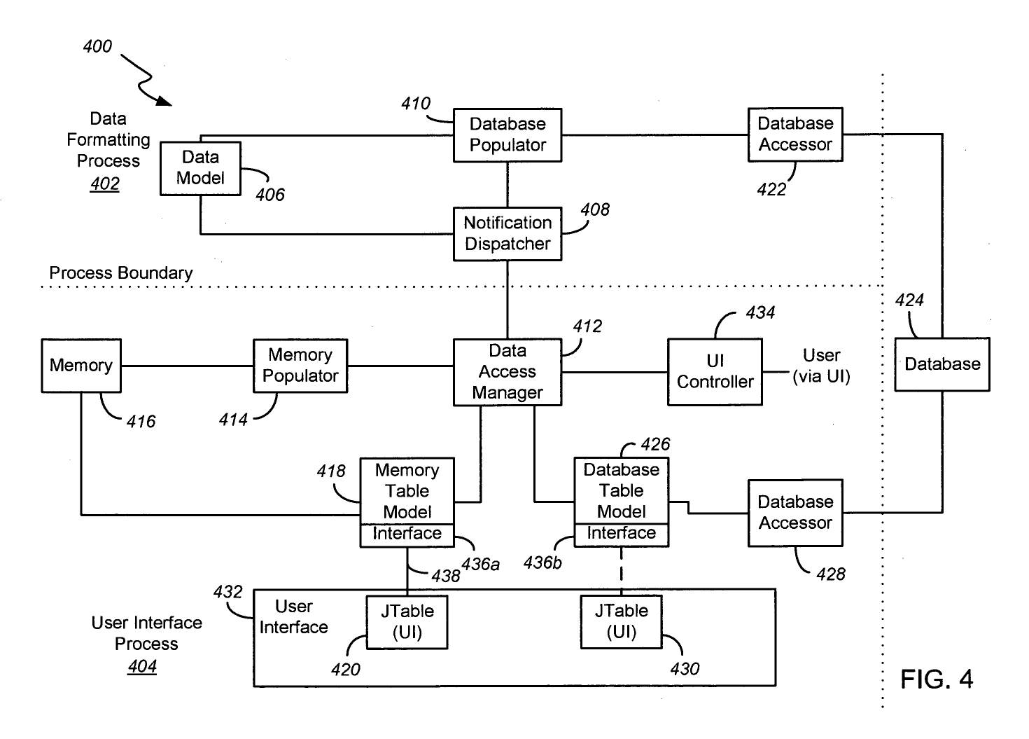

FIG. 4 illustrates an exemplary test system 400 to which the method 100 may be applied. The test system 400 comprises a data formatting process 402 and a user interface process 404. The data formatting process 402 receives test data that is generated during test of a device under test, and formats and saves the test data in a data model 406. A notification dispatcher 408 then notifies the user interface process 404 that new data is available, and the user interface process 404 displays the new data to a user. A user interface (UI) controller 434 provides a mechanism by which a user can, among other things, select a test application mode of the test system 400, or set a user preference regarding clearing data. In one embodiment, the test application modes include a production test mode and a debug test mode.

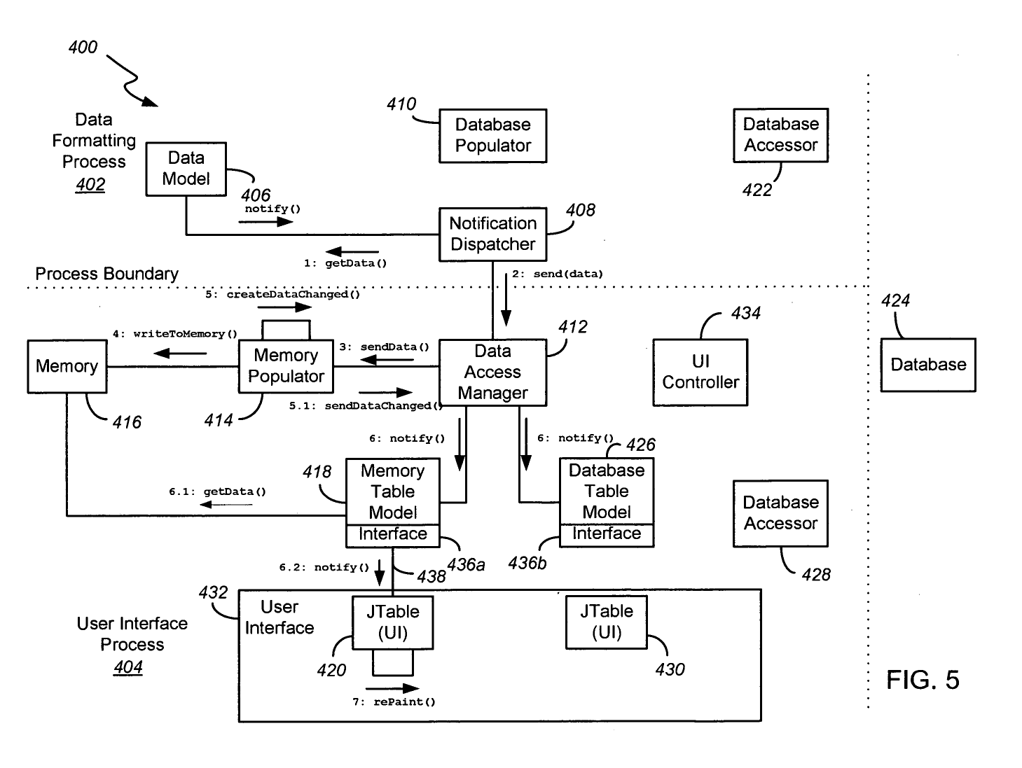

The test system 400 operates as follows. When the test system 400 is in the production test mode, and as shown in FIG. 5, the notification dispatcher 408 retrieves new test data items from the data model 406 and sends them to a data access manager 412 of the user interface process 404. The data access manager 412 then sends the new test data items to a memory populator 414, which in turn writes the new test data items to the memory 416 (i.e., volatile storage). Upon writing the new test data items to the memory 416, the memory populator 414 notifies the data access manager 412, which in turn notifies the memory table model 418. The table model 418 then dynamically compiles or updates its set of test data items, as necessary, and notifies a Java™ Swing™ JTable 420 of the user interface 432. Using its reference to the table model 418, the JTable 420 repaints (i.e., updates) the user interface 432.

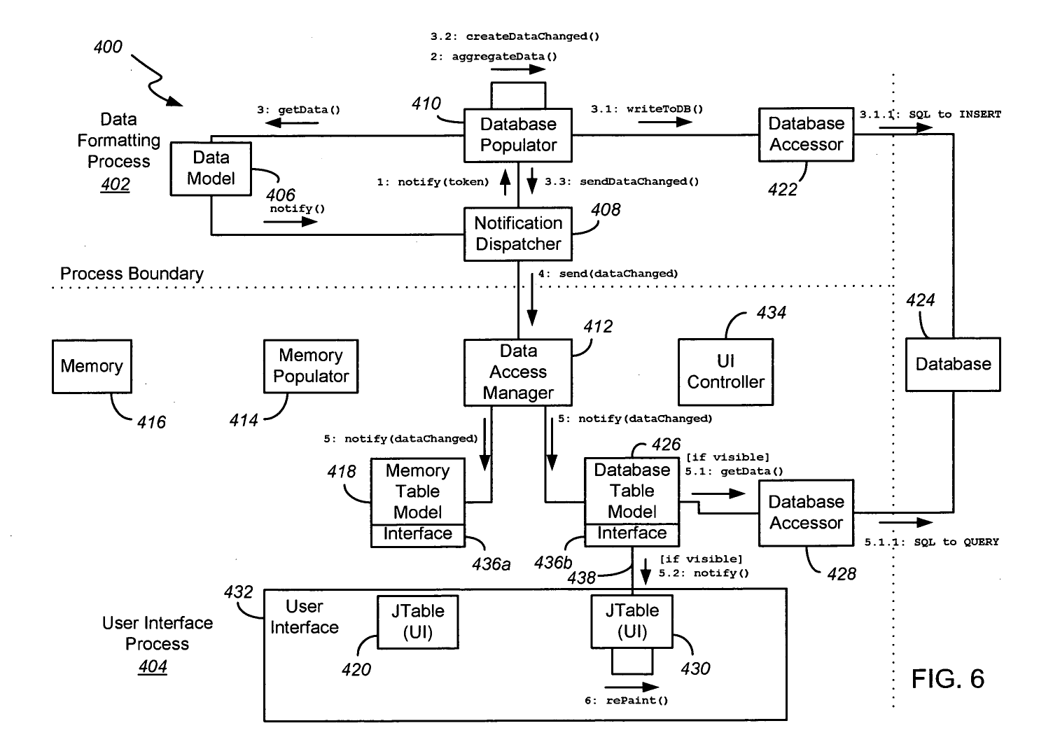

When the test system 400 is in a debug test mode, and as shown in FIG. 6, the notification dispatcher 408 notifies a database populator 410 that new test data items are available. The database populator 410 then retrieves the new test data items from the data model 406 and writes them to a database 424 (i.e., nonvolatile storage) via a database accessor 422. Upon writing the new test data items to the database 424, the database populator 410 notifies the notification dispatcher 408, which in turn notifies the data access manager 412. The data access manager 412 then notifies the database table model 426, and the table model 426 dynamically compiles or updates its set of test data items, as necessary, by accessing the new test data items in the database 424 via a database accessor 428. The table model 426 subsequently notifies a Java™ Swing™ JTable 430 of the user interface 432. Using its reference to the table model 426, the JTable 430 repaints (i.e., updates) the user interface 432.

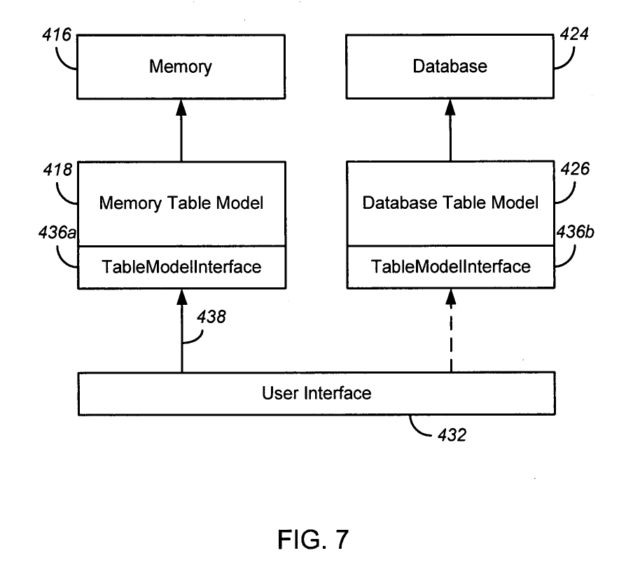

FIG. 7 illustrates a first exemplary implementation of the user interface 432. As shown, the user interface 432 contains a reference 438 to one of a number of table model objects 418, 426 that implement instances 436a, 436b of a common table model interface, such as the Java™ Swing™ TableModelInterface. In one embodiment, the object may be a memory table model 418 that holds a set of production test data items, or a database table model 426 that holds a set of debug test data items. The memory table model 418 may access production test data from memory 416, and the database table model 426 may access debug test data from the database 424. The user interface 432 operates the same, regardless of the table model 418, 426 that it references. Computer-readable code may dynamically switch the user interface's reference 438 to point to the table model 418 or the table model 426, depending on the state of the test application mode (e.g., production test mode or debug test mode). Of note, both of the table models 418, 426 may be stored in the memory 416, or in a separate display buffer.

In the test system 400 (FIG. 4), and by way of example, computer-readable code switches the user interface's reference 438 to point to the table model 418 or the table model 426 by respectively and dynamically configuring the user interface 432 to incorporate 1) a first table object (e.g., a first Java™ Swing™ JTable 420) that accesses the interface 436a of the table model 418, or 2) a second table object (e.g., JTable 430) that accesses the interface 436b of the table model 426.

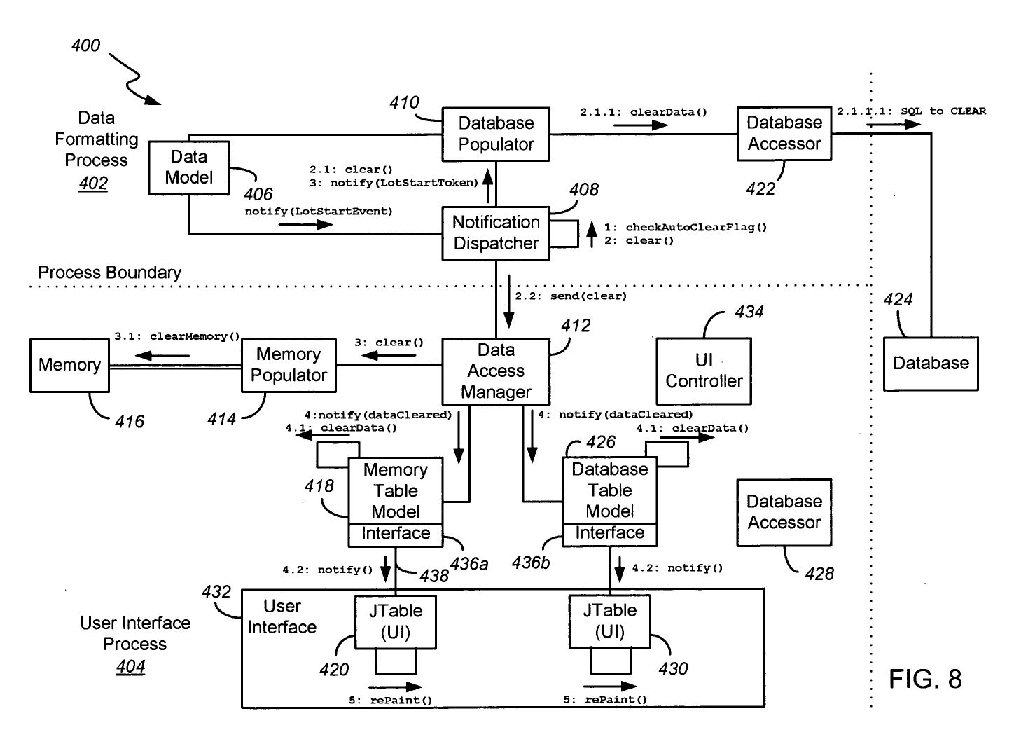

Assuming that different sets of test data items correspond to different “lots” of devices, and assuming that different sets of test data items are associated with respective “lot” identifiers, FIG. 8 illustrates how the method 100 may be applied to the test system 400. As test data items are read and compiled into the data model 406, “lot start” events (i.e., “lot identifiers) are encountered and notifications of same are sent to the notification dispatcher 408. The notification dispatcher 408 checks a user preference (e.g., a flag) that indicates whether a user has allowed or enabled an automatic clearing of test data items. If automatic clearing has been enabled, the notification dispatcher 408 notifies the database populator 410, which in turn initiates a clear of the database 424 via the data accessor 422. At the same time, the notification dispatcher 408 notifies the data access manager 412 that a clear should be initiated. The data access manager 412 then initiates a clear of the memory 416 via the memory populator 414, while also notifying the table models 418, 426 that their data should be cleared. The table models 418, 426 then initiate a clear process and also notify the JTables 420, 430 that they should initiate a repaint to clear what is displayed via the user interface 432.

In one embodiment, the reading of a lot identifier (or the processing of a “lot start” event) initiates the clearing of test data items from all data storage resources in which test data items reside, including the database 424, the memory 416, the table models 418, 426 and the JTables 420, 430. In another embodiment, only those data storage resources 416, 418, 420 that store production test data are cleared (since these are the resources where storage space is limited, and performance is most critical).

As previously mentioned, FIGS. 2 & 3 illustrate exemplary windows 202, 300 of a user interface 200 that may be configured via the method 100. By way of example, the window 202 displays a plurality of test data entries 204, 206 and 208, each of which includes a plurality of test data items. By way of example, each test data entry 204, 206, 208 includes three test result identifiers, including: a “Test Number”, a “Test or Measurement Name”, and a “TestSuite Name” that identifies a test suite to which the test name and number belong. In addition, each test data entry 204, 206, 208 comprises information identifying the test resources via which a test result was acquired (e.g., a test “Site” number), and information identifying the device and pin for which a test result was acquired (e.g., a device “Part ID”, and a device “Pin Name”). Each test data entry 204, 206, 208 also comprises one or more test results, which may take forms such as a value in a “Result” field and/or a check in a “Fail” field (e.g., for those tests that have failed). For measurement-type test results, “Unit”, “Low Limit” and “High Limit” fields may also be populated.

Preferably, the window 202 is displayed during execution of a plurality of tests on which the test data entries 204, 206, 208 are based (i.e., during test of a device under test). New test results can then be displayed via the window as they are acquired, and a user can be provided a “real-time” display of test results. Alternately, device testing can be completed, and a log of test results can be saved to volatile or nonvolatile storage (e.g., memory or a hard disk). The test results can then be read and displayed in succession via the window 202 (i.e., not in real-time). Typically, the test data entries 204, 206, 208 that are displayed at any one time represent only some of the test data entries or items that are generated during execution of a plurality of tests. One or more mechanisms such as a scroll bar 230 may be provided to allow a user to navigate to different test data entries or items.

By way of example, FIG. 2 illustrates a display of production test data 228 (i.e., a display in which the test data entries 204, 206, 208 pertain to production test data). A graphical button 212 labeled “Production” is associated with the production display 228 and serves as both a production mode identifier and production mode selector. Similarly, a graphical button 214 labeled “Debug” is associated with a display of debug test data and serves as both a debug mode identifier and selector. In one embodiment of the GUI 200, the buttons 212, 214 are displayed via the window 202 at all times.

As a result of FIG. 2 illustrating a display of production test data 228, the “Production” button 212 is shown depressed, and the “Debug” button 214 is shown un-depressed. If a user graphically clicks on the “Debug” button 214, the window 202 may be updated to show the “Debug” button 214 depressed and the “Production” button 212 un-depressed. In addition, the GUI 200 may be updated to focus on a display of debug test data. When the GUI 200 is updated, the test data entries 204, 206, 208 shown in the common fill area 216 may be replaced with test data entries pertaining to a debug mode. Alternately, the production display 228 and debug display could comprise respective and different windows of the GUI 200, and an update of the GUI 200 to focus on the production display 228 or the debug display could result in a pertinent one of the windows being launched and/or brought to the front of the GUI (i.e., overlaid over the other window).

As further shown in FIG. 2, each of the test data entries 204, 206, 208 may be displayed as a line of a table 210, with different lines of the table corresponding to different ones of the test data entries 204, 206, 208. For purposes of this description, a “table” is defined to be either an integrated structure wherein data is displayed in tabular form, or multiple structures that, when displayed side-by-side, enable a user to review information in rows and columns.

What is claimed is:

1. A computer-implemented method for compiling and displaying test data items, comprising:
serially compiling different sets of test data items in, and serially reading the different sets of test data items from, a data storage resource, wherein each of the sets of test data items corresponds to one of a plurality of defined groupings of devices under test;
as the different sets of test data items are read from the data storage resource, displaying, via a user interface, at least a dynamically updated range of the test data items read from the data storage resource; and
before compiling a next set of test data items in the data storage resource, clearing a previously compiled set of test data items from the data storage resource, thereby clearing any of the previously compiled set of test data items from the user interface.

2. The method of claim 1, wherein the defined groupings of devices under test are lots of devices under test.

3. The method of claim 1, wherein the data storage resource comprises volatile storage.

4. The method of claim 1, wherein the data storage resource comprises random access memory (RAM).

5. The method of claim 1, wherein the defined groupings of devices under test are lots of devices under test, and wherein the data storage resource comprises random access memory (RAM).

6. The method of claim 1, wherein the data storage resource comprises a data table stored in random access memory (RAM).

7. The method of claim 1, wherein the data storage resource comprises a display buffer.

8. The method of claim 1, wherein the data storage resource comprises nonvolatile storage.

9. The method of claim 1, wherein the devices under test are memory devices.

10. The method of claim 1, wherein the devices under test are system-on-a-chip (SOC) devices.

11. The method of claim 1, wherein each of the different sets of test data items is associated with a respective lot identifier; wherein the method further comprises reading each of the lot identifiers before its associated set of test data items is compiled in the data storage resource; and wherein clearing a previously compiled set of test data items from the data storage resource comprises clearing a previously compiled set of test data items upon reading the lot identifier associated with a next set of test data items to be compiled in the data storage resource.

12. The method of claim 1, further comprising, checking a user preference regarding clearing data, and only initiating said clearing of a previously compiled set of test data items when the user preference indicates a desire to perform said clearing.

13. Apparatus for compiling and displaying test data items, comprising:
computer-readable media;
computer-readable code, stored on the computer-readable media, including,
code to cause a computer to serially compile different sets of test data items in, and serially read the different sets of test data items from, a data storage resource, wherein each of the sets of test data items corresponds to one of a plurality of defined groupings of devices under test;
code to, as the different sets of test data items are read from the data storage resource, cause the computer to display, via a user interface, at least a dynamically updated range of the test data items read from the data storage resource; and
code to, before a next set of test data items is compiled in the data storage resource, cause the computer to clear a previously compiled set of test data items from the data storage resource, and thereby clear any of the previously compiled set of test data items from the user interface.

14. The apparatus of claim 13, wherein the defined groupings of devices under test are lots of devices under test.

15. The apparatus of claim 13, wherein the data storage resource comprises volatile storage.

16. The apparatus of claim 13 wherein the data storage resource comprises random access memory (RAM).

17. The apparatus of claim 13, wherein the devices under test are memory devices.

18. The apparatus of claim 13, wherein the devices under test are system-on-a-chip (SOC) devices.

19. The apparatus of claim 13, wherein each of the different sets of test data items is associated with a respective lot identifier; wherein the apparatus further comprises code to cause the computer to read each of the lot identifiers before its associated set of test data items is compiled in the data storage resource; and wherein clearing a previously compiled set of test data items from the data storage resource comprises clearing a previously compiled set of test data items upon reading the lot identifier associated with a next set of test data items to be compiled in the data storage resource.

20. The apparatus of claim 13, further comprising code to cause the computer to check a user preference regarding clearing data, and only initiate said clearing of a previously compiled set of test data items when the user preference indicates a desire to perform said clearing.
